(19) United States
(12) Patent Application Publication
(10) Pub. No.: US 2025/0130363 A1
(43) Pub. Date: Apr. 24, 2025

(54) POLARIZATION-MAINTAINING FIBER

(71) Applicant: FUJIKURA LTD., Tokyo (JP)

(72) Inventors: Yoshikazu Sasaki, Chiba (JP); Kazuyuki Hayashi, Chiba (JP); Shoichiro Matsuo, Chiba (JP)

(73) Assignee: FUJIKURA LTD., Tokyo (JP)

(21) Appl. No.: 18/834,333

(22) PCT Filed: Jan. 27, 2023
(86) PCT No.: PCT/JP2023/002603

§ 371 Date: Jul. 30, 2024

(30) Foreign Application Priority Data
Jan. 31, 2022 (JP) 2022-013537

(51) Int. Cl. G02B 6/024; G02B 6/02

(52) U.S. Cl. CPC G02B 6/024; G02B 6/02004

(57) ABSTRACT

A polarization maintaining fiber includes a core, paired stress applying parts disposed on both sides of the core, and a clad encompassing the core and the paired stress applying parts. When the polarization maintaining fiber has a fiber length of 2 m and a bend radius of 140 mm, the polarization maintaining fiber has a cut-off wavelength equal to or greater than 1.41 μm and less than 1.55 μm, and when the polarization maintaining fiber has a bend radius of 5 mm and twists at a rate of one rotation per 31.4 mm of fiber length, the polarization maintaining fiber has a bending loss equal to or less than 7 dB at a wavelength of 1.55 μm.

### BACKGROUND

### Technical Field

The present invention relates to a polarization maintaining fiber including paired stress applying parts.

### Discussion of the Background

Optical digital coherent communication has been widely used in order to deal with increase in optical communication capacity due to prevalence of smartphones and growing diversity of data services. In addition, an attempt has been recently considered to further increase capacities of the optical digital coherent communication by increasing the number of optical transceivers used for the optical digital coherent communication.

Polarization maintaining fibers are used for connection of devices that carry out the optical digital coherent communication. For example, Patent Literature 1 is one document that discloses a polarization maintaining fiber.

### Patent Literature

Patent Literature 1: JP Patent Publication No. 2018-159926

### SUMMARY

In order to increase the number of the optical transceivers, the optical transceivers may be made compact. However, in a case where the polarization maintaining fiber is housed in a compact optical transceiver, the polarization maintaining fiber needs to be bent in a small bend radius, resulting in degradation in communication quality caused by an increase of a bending loss. In addition, in a case where the polarization maintaining fiber is housed in the compact optical transceiver, the polarization maintaining fiber may be twisted as well as bent.

The inventors thus studied a bending loss in the twisted polarization maintaining fiber. As a result, the inventors have found that the bending loss in a twisted polarization maintaining fiber is much larger than that in an untwisted polarization maintaining fiber.

One or more embodiments provide a polarization maintaining fiber that makes it possible to reduce a bending loss to be small enough to allow for normal use, even when undergoing twisting that may occur when the polarization maintaining fiber is housed in an optical transceiver or applied to a sensor.

A polarization maintaining fiber in accordance with one or more embodiments includes: a core; paired stress applying parts provided on both sides of the core; and a clad encompassing the core and the paired stress applying parts, wherein in a case where the polarization maintaining fiber has a fiber length of 2 m and a bend radius of 140 mm, the polarization maintaining fiber has a cut-off wavelength of not less than 1.41 μm and less than 1.55 μm, and in a case where the polarization maintaining fiber has a bend radius of 5 mm and undergoes twisting at a rate of one rotation per 31.4 mm of fiber length, the polarization maintaining fiber exhibits a bending loss of not more than 7 dB at a wavelength of 1.55 μm.

According to one or more embodiments, it is possible to achieve a polarization maintaining fiber that makes it possible to reduce a bending loss to be small enough to allow for normal use, even when undergoing twisting that may occur when the polarization maintaining fiber is housed in an optical transceiver or applied to a sensor.

### BRIEF DESCRIPTION OF THE DRAWINGS

FIG. 1 shows a cross-sectional view illustrating a transverse cross-section of a polarization maintaining fiber in accordance with one or more embodiments and a graph showing a refractive index distribution along AA′ line in the cross-section of the polarization maintaining fiber.

### DESCRIPTION OF THE EMBODIMENTS

### Structure of Polarization Maintaining Fiber

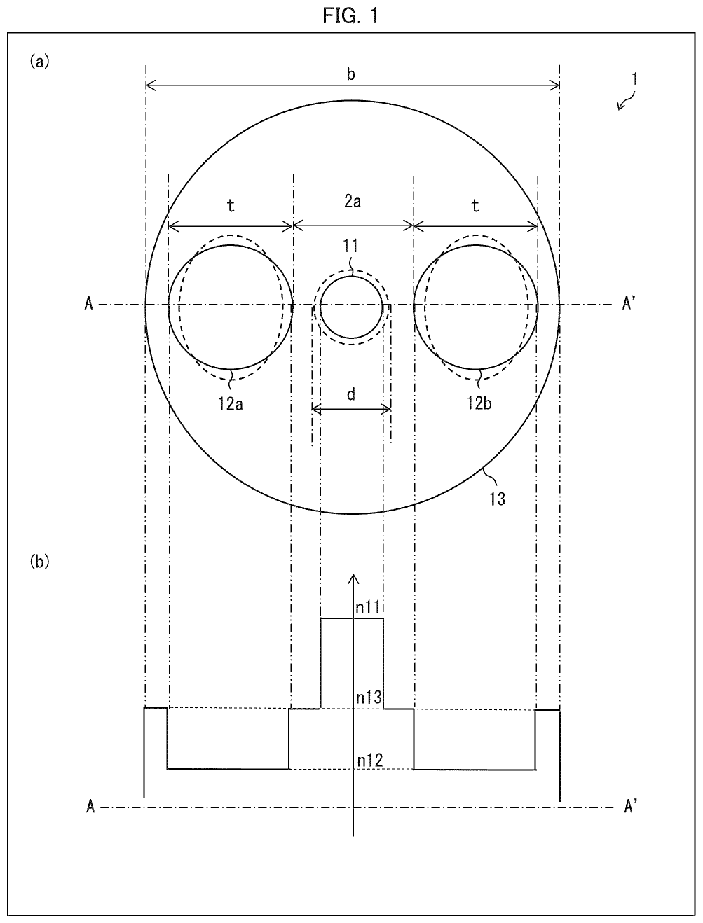

With reference to FIG. 1, the following description will discuss a structure of a polarization maintaining fiber 1 in accordance with one or more embodiments. (a) of FIG. 1 is a cross-sectional view illustrating a transverse cross-section of the polarization maintaining fiber 1. (b) of FIG. 1 is a graph showing a refractive index distribution of the polarization maintaining fiber 1 along AA′ line in the cross-section illustrated in (a) of FIG. 1. Here, the transverse cross-section refers to a cross-section orthogonal to the center axis of the polarization maintaining fiber 1.

As illustrated in (a) of FIG. 1, the polarization maintaining fiber 1 includes a core 11, paired stress applying parts 12a and 12b provided on both sides of the core 11, and a clad 13 encompassing the core 11 and the paired stress applying parts 12a and 12b. Note that the polarization maintaining fiber 1 may include a coating covering the clad 13. The polarization maintaining fiber 1 may be called a polarization-maintaining AND absorption-reducing (PANDA) fiber.

The core 11 is a section in the shape of a pole extending in a center axis direction of the polarization maintaining fiber 1. The core has a refractive index n11 higher than the refractive index n13 of the clad 13. The core 11 is made of, for example, quartz glass containing updopant. Examples of the updopant contained in the core 11 include germanium (Ge).

In one or more embodiments, a cross-sectional shape of the core 11 is a circular shape. Note, however, that the cross-sectional shape of the core 11 is not limited to this. The cross-sectional shape of the core 11 may be, for example, an elliptical shape, a crescent shape, or a noncircular shape. Note that the cross-sectional shape of the core 11 refers to a shape of a cross-section orthogonal to the center axis of the polarization maintaining fiber 1, among the cross-sections of the core 11.

The stress applying parts 12a and 12b are sections in the shape of a pole extending in a center axis direction of the polarization maintaining fiber 1. The stress applying parts 12a and 12b each have a refractive index n12 lower than the refractive index n13 of the clad. The stress applying parts 12a and 12b are made of, for example, quartz glass containing downdopant. Examples of the downdopant contained in the stress applying parts 12a and 12b include boron (B) and fluorine (F).

In one or more embodiments, the cross-sectional shape of each of the stress applying parts 12a and 12b is a circular shape (illustrated by the actual line) or an elliptical shape (illustrated by the dotted line) having a short-axis direction corresponding to a direction in which the stress applying parts 12a and 12b are arranged. Note, however, that the cross-sectional shape of each of the stress applying parts 12a and 12b is not limited to these. The cross-sectional shape of each of the stress applying parts 12a and 12b may be, for example, a crescent shape or a noncircular shape. Note that the cross-sectional shape of each of the stress applying parts 12a and 12b refers to a shape of a cross-section orthogonal to the center axis of the polarization maintaining fiber 1, among the cross-sections of the stress applying parts 12a and 12b.

Note that in one or more embodiments, the stress applying parts 12a and 12b are each spaced from the core 11. This makes it possible to achieve the polarization maintaining fiber 1 satisfying Condition 2 or Condition 3 which will be described later. This also makes it possible to reduce a possibility that the core 11 undergoes an unexpected deformation due to stresses from the stress applying parts 12a and 12b when the polarization maintaining fiber 1 is manufactured through melt-stretching. In addition, in a case where the core 11 is in contact with the stress applying parts 12a and 12b (for example, in a manner such that the core 11 cuts into the stress applying parts 12a and 12b), a transmission loss is degraded due to misalignment between the materials. In contrast, when the core 11 is spaced from the stress applying parts 12a and 12b, it is possible to suppress the degradation of the transmission loss caused by misalignment between the structures.

The clad 13 is a section in the shape of a pole extending in a center axis direction of the polarization maintaining fiber 1. As described above, the refractive index n13 of the clad 13 is lower than the refractive index n11 of the core 11 and is higher than the refractive index n12 of each of the stress applying parts 12a and 12b. The clad 13 is made of, for example, quartz glass.

In one or more embodiments, a cross-sectional shape of the clad 13 is a circular shape. Note, however, that the cross-sectional shape of the clad 13 is not limited to this. The cross-sectional shape of the clad 13 may be, for example, an elliptical shape, a crescent shape, or a noncircular shape. Note that the cross-sectional shape of the clad 13 refers to a shape of a cross-section orthogonal to the center axis of the polarization maintaining fiber 1, among the cross-sections of the clad 13.

The clad diameter is preferably not more than 80 μm. In this case, for example, at the housing in an optical transceiver or the application to a sensor, space saving can be achieved, thereby making it possible to achieve high-density mounting. The rigidity can be reduced to be small, thereby making it possible to reduce decrease in mechanical strength of the polarization maintaining fiber 1 which occurs when the polarization maintaining fiber 1 is twisted.

A feature of the polarization maintaining fiber 1 in accordance with one or more embodiments is to satisfy the following Condition 1.

Condition 1: In a case where a bend radius is 5 mm and there is twisting at a rate of one rotation per 31.4 mm of fiber length (per one turn or approximately one turn), a bending loss at a wavelength of 1.55 μm is not more than 7 dB.

This exerts an effect of making it possible to reduce the bending loss in the polarization maintaining fiber 1 to be small enough to allow for normal use even when the polarization maintaining fiber 1 undergoes twisting that may occur in normal use. Here, the “twisting that may occur in normal use” refers to, for example, twisting that occurs when the polarization maintaining fiber 1 is housed in a housing of an optical transceiver or when the polarization maintaining fiber 1 is applied to a sensor. Further, the “bending loss that allows for normal use” refers to, for example, a bending loss that allows information superimposed on the signal light to be maintained in optical communication using the polarization maintaining fiber 1.

In the above Condition 1, the above bending loss may be any value of not more than 7 dB. Therefore, for example, the scope of the disclosure of the present specification also encompasses, as the polarization maintaining fiber 1 exerting the above effect, the polarization maintaining fibers 1 satisfying Condition 1 from which polarization maintaining fibers 1 each exhibiting the above bending loss of a specific value or polarization maintaining fibers 1 each exhibiting the above bending loss falling within a specific numerical range are excluded.

The bending loss in the polarization maintaining fiber 1 twisted tends to be the smallest at a cut-off wavelength thereof. Therefore, when the cut-off wavelength is close to an operating wavelength (in one or more embodiments, 1.55 μm) thereof, it is possible to reduce an amount of light that leaks out of the core 11 into the clad 13 in a case where there are twisting and bending. Further, when the cut-off wavelength is smaller than the operating wavelength, it is possible to achieve single-mode transmission at the operating wavelength. The inventors of the present application focused on these points, and have found that in a case where the cut-off wavelength satisfies the following Condition 1a, it is possible to achieve the polarization maintaining fiber 1 in which the bending loss exhibited in a case where the polarization maintaining fiber 1 is twisted satisfies the above Condition 1 and which enables the single-mode transmission at the operating wavelength.

Condition 1a: In a case where that a fiber length is 2 m and a bend radius is 140 mm, a cut-off wavelength is not less than 1.41 μm and less than 1.55 μm.

In the above Condition 1a, the cut-off wavelength may be any value of not less than 1.41 μm and less than 1.55 μm. Therefore, for example, the scope of the disclosure of the present specification also encompasses, as the polarization maintaining fiber 1 satisfying the above Condition 1, the polarization maintaining fibers 1 satisfying Condition 1 and Condition 1a from which polarization maintaining fibers 1 each having the above cut-off wavelength of a specific value or polarization maintaining fibers 1 each having the above cut-off wavelength falling within a specific numerical range are excluded.

Note that the cut-off wavelength may shift to a long-wavelength side due to a lateral pressure (for example, a lateral pressure caused by degradation of a resin coating covering a side surface of the polarization maintaining fiber 1) or disturbance to the polarization maintaining fiber 1. Considering this point, it is preferable that a certain margin is present between the upper limit of the cut-off wavelength and the operating wavelength. This is because even in a case where the cut-off wavelength shifts to the long-wavelength side due to the lateral pressure or the disturbance, it is possible to reduce a possibility that the cut-off wavelength exceeds the operating wavelength, that is, the single-mode transmission at the operating wavelength becomes difficult to achieve. Here, for example, setting the lower limit of the cut-off wavelength to be 1.41 μm makes it possible to reduce the situation in which the cut-off wavelength exceeds the operating wavelength, even if the cut-off wavelength shifts to the long-wavelength side due to the lateral pressure or the disturbance. Therefore, it is possible to further reduce the possibility that the single-mode transmission at the operating wavelength becomes difficult to achieve.

In addition, a larger relative refractive index difference of the core 11 with respect to the clad 13 tends to result in closer confinement of light propagating in the core 11 into the core 11. Therefore, the polarization maintaining fiber 1 that exhibits a larger relative refractive index difference of the core 11 with respect to the clad 13 makes it possible to reduce the bending loss exhibited in a case where the polarization maintaining fiber 1 is twisted, to be smaller. Therefore, in a case where the relative refractive index difference of the core 11 with respect to the clad 13 satisfies the following Condition 1b, it is possible to more reliably satisfy the above Condition 1.

Condition 1b: A relative refractive index difference of the core 11 with respect to the clad 13 is not less than 0.36%.

In addition, a smaller mode field diameter at the operating wavelength (in one or more embodiments, 1.55 μm) leads to closer confinement of light propagating in the core 11 into the core 11. Therefore, the polarization maintaining fiber 1 having a smaller mode field diameter at the operating wavelength makes it possible to reduce a bending loss exhibited in a case where the polarization maintaining fiber 1 is twisted, to be smaller. Thus, in a case where the mode field diameter at the operating wavelength satisfies the following Condition 1c, it is possible to more reliably satisfy the above Condition 1.

Condition 1c: A mode field diameter at a wavelength of 1.55 μm is not more than 9.2 μm.

In the above Condition 1b, the relative refractive index difference may be any value of not less than 0.36%. Therefore, for example, the scope of the disclosure of the present specification also encompasses, as the polarization maintaining fiber 1 satisfying the above Condition 1, the polarization maintaining fibers 1 satisfying the above Conditions 1a, 1b, and 1c from which polarization maintaining fibers 1 each exhibiting the above relative refractive index difference of a specific value or polarization maintaining fibers 1 each exhibiting the above relative refractive index difference falling within a specific numerical range are excluded.

In the above Condition 1c, the mode field diameter may be any value of not more than 9.2 μm. Therefore, for example, the scope of the disclosure of the present specification also encompasses, as the polarization maintaining fiber 1 satisfying the above Condition 1, the polarization maintaining fibers 1 satisfying the above Conditions 1a, 1b, and 1c from which polarization maintaining fibers 1 each having the above mode field diameter of a specific value or each having the above mode field diameter falling within a specific numerical range are excluded.

### Examples of Polarization Maintaining Fiber

Table 1 shows results of measurement of (i) bending losses exhibited by seven types of polarization maintaining fibers A to G in a case where each of them is wound ten turns around a mandrel with a radius of 5 mm without twisting and (ii) bending losses exhibited by them in a case where each of them is wound ten turns around a mandrel with a radius of 5 mm with twisting at a rate of one rotation) (360°) per 31.4 mm of fiber length.

TABLE 1

| Items | Unit | A | B | C | D | E | F | G |
|---|---|---|---|---|---|---|---|---|
| Operating | μm | 1.55 | 1.55 | 1.55 | 1.55 | 1.55 | 1.55 | 1.55 |
| wavelength | | | | | | | | |
| Cut-off | μm | 1.41 | 1.45 | 1.47 | 1.51 | 1.45 | 1.28 | 1.33 |
| wavelength: | | | | | | | | |
| (Fiber | | | | | | | | |
| length: 2 m | | | | | | | | |
| R = 140 | | | | | | | | |
| mm) | | | | | | | | |
| Mode field | μm | 9.2 | 9.1 | 8.8 | 8.4 | 8.0 | 9.4 | 9.4 |
| diameter | | | | | | | | |
| Clad | μm | 80 | 80 | 80 | 80 | 80 | 80 | 125 |
| diameter | | | | | | | | |
| Relative | % | 0.36 | 0.41 | 0.45 | 0.5 | 0.55 | 0.33 | 0.35 |
| refractive | | | | | | | | |
| index | | | | | | | | |
| difference | | | | | | | | |
| Bending | dB | 0.20 | 0.04 | 0.16 | 0.01 | 0.16 | 0.54 | 0.98 |
| loss (10 | | | | | | | | |
| turns with | | | | | | | | |
| R = 5 mm, | | | | | | | | |
| no twisting) | | | | | | | | |
| Bending | dB | 7.0 | 2.8 | 1.2 | 0.5 | 0.4 | 34.7 | 11.0 |
| loss (10 | | | | | | | | |
| turns with | | | | | | | | |
| R = 5 mm, | | | | | | | | |
| twisting | | | | | | | | |
| once per | | | | | | | | |
| one turn) | | | | | | | | |

Note that Table 1 also shows operating wavelengths, cut-off wavelengths, mode field diameters, clad diameters, and relative refractive index differences, as parameters particularly dominantly affecting the bending losses. Here, the cut-off wavelength is a cut-off wavelength of a case where the fiber length is 2 m and the bend radius is 140 mm. The mode field diameter is a mode field diameter at a wavelength of 1.55 μm (operating wavelength). The relative refractive index difference is a relative refractive index difference of the core with respect to the clad.

Table 1 indicates that the polarization maintaining fibers A to E satisfy the above Condition 1 and Condition 1a. Therefore, the polarization maintaining fibers A to E correspond to Examples. In contrast, Table 1 indicates that the polarization maintaining fibers F to G fail to satisfy the above Condition 1. Therefore, the polarization maintaining fibers F to G correspond to Comparative Examples.

The polarization maintaining fibers A to E in accordance with Examples exhibited relative refractive index differences of not less than 0.36%. In contrast, the polarization maintaining fibers F to G in accordance with Comparative Examples exhibited relative refractive index differences of less than 0.36%. Therefore, it was confirmed that the relative refractive index difference preferably satisfies the above Condition 1b in order for a polarization maintaining fiber to satisfy the above Condition 1. Note that the polarization maintaining fibers A to E in accordance with Examples exhibited relative refractive index differences of not more than 0.55%. Therefore, in order for a polarization maintaining fiber to more reliably satisfy the above Condition 1, the relative refractive index difference preferably satisfies Condition 1b′ below. Note, however, that the condition effective for reducing the bending loss when there is twisting is a relative refractive index difference being not less than 0.36%, while a relative refractive index difference being not more than 0.55% is not essential for satisfying Condition 1.

Condition 1b′: A relative refractive index difference of the core 11 with respect to the clad 13 is not less than 0.36% and not more than 0.55%.

In addition, the polarization maintaining fibers A to E in accordance with Examples had mode field diameters of not more than 9.2 μm. In contrast, the polarization maintaining fibers F to G in accordance with Comparative Examples had mode field diameters of greater than 9.2 μm. Therefore, it was confirmed that the mode field diameter preferably satisfies the above Condition 1c in order for a polarization maintaining fiber to satisfy the above Condition 1. Note that the polarization maintaining fibers A to E in accordance with Examples had mode field diameters of not less than 8.0 μm. Therefore, in order for a polarization maintaining fiber to more reliably satisfy the above Condition 1, the mode field diameter preferably satisfies Condition 1c′ below. Note, however, that the condition effective for reducing the bending loss when there is twisting is a mode field diameter being not more than 9.2 μm, while a mode field diameter being not less than 8.0 μm is not essential for satisfying Condition 1.

Condition 1c′: A mode field diameter at a wavelength of 1.55 μm is not less than 8.0 μm and not more than 9.2 μm.

In light sources, such as tunable laser usable in optical transceivers or sensors, the diameter of outgoing light at a 1.55 μm band is typically not less than 8.0 μm and not more than 9.5 μm, for example. In a case where the polarization maintaining fiber 1 satisfies Condition 1c′, it is possible to reduce a difference between the outgoing light diameter of such a light source and the mode field diameter of the polarization maintaining fiber 1 to be small. Therefore, a polarization maintaining fiber satisfying the above Condition 1c′ has an additional advantage of making it possible to reduce a connection loss at connection with such a light source. Further, in a case where the value of not less than 8.0 μm in the Condition 1c′ is satisfied, the mode field diameter tends to be large. Therefore, in a case of a polarization maintaining fiber satisfying the above Condition 1c′, light sources each of which has a relatively large outgoing light diameter at a 1.55 μm band among the above-described light sources make it possible to reduce a connection loss between the light source and the polarization maintaining fiber. Further, in a case where the value of not more than 0.55% in the above Condition 1b′ is satisfied, the mode field diameter tends to be large. Therefore, in a case of a polarization maintaining fiber satisfying the above Condition 1b′, light sources each of which has a relatively large outgoing light diameter at a 1.55 μm band among the above-described light sources make it possible to reduce a connection loss between the light source and the polarization maintaining fiber.

Table 2 shows a result of measurement of (i) polarized-wave crosstalk exhibited by each of the polarization maintaining fibers A to F shown in Table 1 at a wavelength of 1.55 μm with neither twisting nor bending, (ii) polarized-wave crosstalk exhibited by each of them at a wavelength of 1.55 μm in a case where each of them is wound ten turns around a mandrel with a radius of 5 mm without twisting, (iii) polarized-wave crosstalk exhibited by each of them at a wavelength of 1.55 μm in a case where each of them is wound ten turns around a mandrel at a radius of 5 mm with twisting at a rate of one rotation) (360°) per 31.4 mm of fiber length, and (iv) a ratio of polarized-wave crosstalk exhibited by each of them at a wavelength of 1.55 μm in a case where each of them is wound ten turns around a mandrel of a radius of 5 mm without twisting with respect to polarized-wave crosstalk exhibited by each of them at a wavelength of 1.55 μm in a case where each of them is wound ten turns around a mandrel with a radius of 5 mm with twisting at a rate of one rotation per 31.4 mm of fiber length.

TABLE 2

| Items | Unit | A | B | C | D | E | F | G |
|---|---|---|---|---|---|---|---|---|
| Operating | μm | 1.55 | 1.55 | 1.55 | 1.55 | 1.55 | 1.55 | 1.55 |
| wavelength | | | | | | | | |
| Clad diameter b | μm | 80 | 80 | 80 | 80 | 80 | 80 | 125 |
| Mode field | μm | 9.2 | 9.1 | 8.8 | 8.4 | 8.0 | 9.4 | 9.4 |
| diameter d | | | | | | | | |
| Stress applying | μm | 25.5 | 25.4 | 24.3 | 25.1 | 22.5 | 25.3 | 35.5 |
| part diameter t | | | | | | | | |
| Stress applying | μm | 5.02 | 5.02 | 5.23 | 5.15 | 4.44 | 4.85 | 7.86 |
| part interval a | | | | | | | | |
| Normalized stress | — | 1.091 | 1.103 | 1.188 | 1.226 | 1.110 | 1.031 | 1.672 |
| applying part | | | | | | | | |
| interval 2a/d | | | | | | | | |
| Normalized stress | — | 0.319 | 0.317 | 0.303 | 0.314 | 0.281 | 0.317 | 0.284 |
| applying part | | | | | | | | |
| diameter t/b | | | | | | | | |
| Stress applying | % | 4.5 | 4.3 | 4.2 | 4.2 | 4.2 | 6.2 | 3.4 |
| part noncircular | | | | | | | | |
| rate | | | | | | | | |
| Polarized-wave | dB | −33 | −32 | −30 | −30 | −30 | −42 | −38 |
| crosstalk (no | | | | | | | | |
| bending, no | | | | | | | | |
| twisting) | | | | | | | | |
| Polarized-wave | dB | −31 | −36 | −32 | −32 | −38 | −25 | −29 |
| crosstalk (10 | | | | | | | | |
| turns with | | | | | | | | |
| R = 5 mm) | | | | | | | | |
| Polarized-wave | dB | −25 | −29 | −30 | −32 | −33 | −14 | −20 |
| crosstalk (10 | | | | | | | | |
| turns with | | | | | | | | |
| R = 5 mm, | | | | | | | | |
| twisting once | | | | | | | | |
| per one turn) | | | | | | | | |
| Polarized-wave | — | 1.24 | 1.26 | 1.08 | 1.00 | 1.18 | 1.81 | 1.44 |
| crosstalk ratio | | | | | | | | |
| (10 turns with | | | | | | | | |
| R = 5 mm no | | | | | | | | |
| twisting/twisting) | | | | | | | | |

Note that Table 2 lists operating wavelengths, clad diameters b, mode field diameters d, stress applying part diameters t, stress applying part intervals a, normalized stress applying part intervals 2a/d, normalized stress applying part diameters t/b, and stress applying part noncircular rates, as parameters particularly dominantly affecting the polarized-wave crosstalk. Here, the stress applying part interval a is a half of the shortest distance between the two stress applying parts 12a and 12b. Further, in a case where the stress applying parts 12a and 12b are each in the shape of a circle, the stress applying part diameter t is a diameter of the circle. In a case where the stress applying parts 12a and 12b are each in the shape of an ellipse, the stress applying part diameter t is an average value of a length of a short axis (twice as large as a short-axis radius) of the ellipse and a length of a long axis (twice as large as a long-axis radius) of the ellipse. Here, the length of the long axis may be regarded as the stress applying part diameter t. In a case where the stress applying parts 12a and 12b are each in a shape other than a circle or an ellipse (for example, have a crescent shape), the stress applying part diameter t is a length of a short axis (twice as large as a short-axis radius) of an imaginary ellipse circumscribing the other shape. The stress applying part noncircular rate is, in a case where the stress applying parts 12a and 12b are each in the shape of an ellipse, a quotient obtained by dividing a difference between the length of the long axis and the length of the short axis by the stress applying part diameter t. The normalized stress applying part interval 2a/d is a value obtained by normalizing a value twice as large as the stress applying part interval a by the mode field diameter d, that is, a quotient obtained by dividing the value twice as large as the stress applying part interval a by the mode field diameter d. Note that in some cases, the normalized stress applying part interval is defined as a value obtained by normalizing the value twice as large as the stress applying part interval a by the core diameter. However, in the present specification, considering that the mode field diameter is a parameter that particularly affects the polarized-wave crosstalk, the normalized stress applying part interval is defined as the value obtained by normalizing the value twice as large as the stress applying part interval a by the mode field diameter d. The mode field diameter highly correlates with the core diameter, and thus the definition of the present specification may be employed. The normalized stress applying part diameter t/b is a value obtained by normalizing the stress applying part diameter t by the clad diameter b, that is, a quotient obtained by dividing the stress applying part diameter t by the clad diameter b.

Table 2 indicates that the polarization maintaining fibers A to E in accordance with Examples satisfy Condition 2 below. Satisfaction of Condition 2 below exerts an effect of making it possible to reduce the polarized-wave crosstalk of the polarization maintaining fiber 1 to be small enough to allow for normal use, even when the polarization maintaining fiber 1 undergoes twisting that may occur in normal use.

Condition 2: In a case where a bend radius is 5 mm and there is twisting at a rate of one rotation per 31.4 mm of fiber length, a polarized-wave crosstalk at a wavelength of 1.55 μm is found to be not more than −25 dB.

In addition, Table 2 indicates that the polarization maintaining fibers A to E in accordance with Examples satisfy Condition 3 below. Satisfaction of Condition 3 below exerts an effect of making it possible to reduce the polarized-wave crosstalk of the polarization maintaining fiber 1 to be small enough to allow for normal use, even when the polarization maintaining fiber 1 undergoes twisting that may occur in normal use.

Condition 3: A ratio of polarized-wave crosstalk exhibited at a wavelength of 1.55 μm in a case where a bend radius is 5 mm and there is no twisting with respect to polarized-wave crosstalk exhibited at a wavelength of 1.55 μm in a case where a bend radius is 5 mm and there is twisting at a rate of one rotation per 31.4 mm of fiber length is found to be not more than 1.26.

Further, as shown in Table 2, the polarization maintaining fibers A to E in accordance with Examples had normalized stress applying part intervals 2a/d of not less than 1.091 and not more than 1.226. Therefore, it was found that in order for a polarization maintaining fiber to satisfy the above Condition 2 or Condition 3, the normalized stress applying part interval 2a/d is preferably not less than 1.091 and not more than 1.226.

Furthermore, as shown in Table 2, the polarization maintaining fibers A to E in accordance with Examples had the normalized stress applying part diameters t/b of not less than 0.281 and not more than 0.319. Therefore, it was found that in order for a polarization maintaining fiber to satisfy the above Condition 2 or Condition 3, the normalized stress applying part diameter t/b is preferably not less than 0.281 and not more than 0.319.

Furthermore, as shown in Table 2, the respective stress applying parts 12a and 12b of the polarization maintaining fibers A to E in accordance with Examples had the noncircular rates of not less than 4.2% and not more than 4.5%. Therefore, it was found that in order for a polarization maintaining fiber to satisfy the above Condition 2 or Condition 3, the noncircular rate of each of the stress applying parts 12a and 12b is preferably not less than 4.2% and not more than 4.5%.

### Additional Remarks 1

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### Additional Remarks 2

A polarization maintaining fiber in accordance with Aspect 1 of one or more embodiments includes: a core; paired stress applying parts provided on both sides of the core; and a clad encompassing the core and the paired stress applying parts, wherein in a case where the polarization maintaining fiber has a fiber length of 2 m and a bend radius of 140 mm, the polarization maintaining fiber has a cut-off wavelength of not less than 1.41 μm and less than 1.55 μm, and in a case where the polarization maintaining fiber has a bend radius of 5 mm and undergoes twisting at a rate of one rotation per 31.4 mm of fiber length, the polarization maintaining fiber exhibits a bending loss of not more than 7 dB at a wavelength of 1.55 μm.

In a polarization maintaining fiber in accordance with Aspect 2 of one or more embodiments, in addition to the configuration of Aspect 1, a configuration is employed in which a relative refractive index difference of the core with respect to the clad is not less than 0.36%, and the polarization maintaining fiber has a mode field diameter of not more than 9.2 μm at a wavelength of 1.55 μm.

In a polarization maintaining fiber in accordance with Aspect 3 of one or more embodiments, in addition to the configuration of Aspect 2, a configuration is employed in which the relative refractive index difference of the core with respect to the clad is not less than 0.36% and not more than 0.55%, and the polarization maintaining fiber has a mode field diameter of not less than 8.0 μm and not more than 9.2 μm at a wavelength of 1.55 μm.

In a polarization maintaining fiber in accordance with Aspect 4 of one or more embodiments, in addition to the configurations of Aspects 1 to 3, a configuration is employed in which in a case where the polarization maintaining fiber has a bend radius of 5 mm and undergoes twisting at a rate of one rotation per 31.4 mm of fiber length, the polarization maintaining fiber exhibits polarized-wave crosstalk of not more than −25 dB at a wavelength of 1.55 μm.

In a polarization maintaining fiber in accordance with Aspect 5 of one or more embodiments, in addition to the configuration of any one of Aspects 1 to 4, a configuration is employed in which a ratio of polarized-wave crosstalk exhibited by the polarization maintaining fiber at a wavelength of 1.55 μm in a case where the polarization maintaining fiber has a bend radius of 5 mm and undergoes no twisting with respect to polarized-wave crosstalk exhibited by the polarization maintaining fiber at a wavelength of 1.55 μm in a case where the polarization maintaining fiber has a bend radius of 5 mm and undergoes twisting at a rate of one rotation per 31.4 mm of fiber length is not more than 1.26.

In a polarization maintaining fiber in accordance with Aspect 6 of one or more embodiments, in addition to the configuration of any one of Aspects 1 to 5, a configuration is employed in which a cross-section orthogonal to a center axis of the polarization maintaining fiber, among cross-sections of each of the paired stress applying parts is in a shape of an ellipse having a short-axis direction corresponding to a direction in which the paired stress applying parts are arranged, and the paired stress applying parts each have a noncircular rate of not less than 4.2% and not more than 4.5%.

In a polarization maintaining fiber in accordance with Aspect 7 of one or more embodiments, in addition to the configuration of any one of Aspects 1 to 6, a configuration is employed in which the paired stress applying parts are each spaced from the core.

In a polarization maintaining fiber in accordance with Aspect 8 of one or more embodiments, in addition to the configuration of any one of Aspects 1 to 7, a configuration is employed in which a normalized stress applying part interval 2a/d obtained by normalizing a value twice as large as a stress applying part interval a by a mode field diameter d at a wavelength of 1.55 μm is not less than 1.091 and not more than 1.226.

In a polarization maintaining fiber in accordance with Aspect 9 of one or more embodiments, in addition to the configuration of any one of Aspects 1 to 8, a configuration is employed in which a normalized stress applying part diameter t/b obtained by normalizing a stress applying part diameter t by a clad diameter b is not less than 0.281 and not more than 0.319.

In a polarization maintaining fiber in accordance with Aspect 10 of one or more embodiments, in addition to the configuration of any one of Aspects 1 to 9, a configuration is employed in which the clad has a clad diameter of not more than 80 μm.

### REFERENCE SIGNS LIST

1 Polarization maintaining fiber
11 Core
12a, 12b Stress applying part
13 Clad

1. A polarization maintaining fiber comprising:
a core;
paired stress applying parts disposed on both sides of the core; and
a clad encompassing the core and the paired stress applying parts, wherein
when the polarization maintaining fiber has a fiber length of 2 m and a bend radius of 140mm, the polarization maintaining fiber has a cut-off wavelength equal to or greater than 1.41 μm and less than 1.55 μm, and
when the polarization maintaining fiber has a bend radius of 5 mm and twists at a rate of one rotation per 31.4 mm of fiber length, the polarization maintaining fiber has a bending loss equal to or less than 7 dB at a wavelength of 1.55 μm.

2. The polarization maintaining fiber according to claim 1, wherein
a relative refractive index difference of the core with respect to the clad is equal to or greater than 0.36%.

3. The polarization maintaining fiber according to claim 1, wherein
a relative refractive index difference of the core with respect to the clad is equal to or less than 0.55%.

4-10. (canceled)

11. The polarization maintaining fiber according to claim 1, wherein the polarization maintaining fiber has a mode field diameter equal to or less than 9.2 μm at the wavelength of 1.55 μm.

12. The polarization maintaining fiber according to claim 1, wherein the polarization maintaining fiber has a mode field diameter equal to or greater than 8.0 μm at the wavelength of 1.55 μm.

13. The polarization maintaining fiber according to claim 1, wherein when the polarization maintaining fiber has the bend radius of 5 mm and twists at the rate of one rotation per 31.4 mm of fiber length, the polarization maintaining fiber has polarized-wave crosstalk equal to or less than −25 dB at the wavelength of 1.55 μm.

14. The polarization maintaining fiber according to claim 1, wherein a ratio of polarized-wave crosstalk, which the polarization maintaining fiber has at the wavelength of 1.55 μm when the polarization maintaining fiber has the bend radius of 5 mm and does not twist, to polarized-wave crosstalk, which the polarization maintaining fiber has at the wavelength of 1.55 μm when the polarization maintaining fiber has the bend radius of 5 mm and twists at the rate of one rotation per 31.4 mm of fiber length, is equal to or less than 1.26.

15. The polarization maintaining fiber according to claim 1, wherein one of cross-sections of each of the paired stress applying parts:
is orthogonal to a center axis of the polarization maintaining fiber, and has an elliptical shape having a short-axis direction in which the paired stress applying parts are arranged,
the paired stress applying parts each have a noncircular rate between 4.2% and 4.5%, inclusive, and
the noncircular rate being is obtained by dividing a difference between a length of a long axis of the elliptical shape and a length of a short axis of the elliptical shape by a stress applying part diameter of each of the paired stress applying parts.

16. The polarization maintaining fiber according to claim 1, wherein the paired stress applying parts are each spaced from the core.

17. The polarization maintaining fiber according to claim 1, wherein the paired stress applying parts each have a stress applying part diameter equal to or greater than 22.5 μm and equal to or less than 25.5 μm.

18. The polarization maintaining fiber according to claim 1, wherein the paired stress applying parts have a stress applying part interval that is:
equal to or greater than 4.44 μm and equal to or less than 5.23 μm, and a half of the shortest distance between the paired stress applying parts.

19. The polarization maintaining fiber according to claim 1, wherein
a normalized stress applying part interval 2a/d, obtained by normalizing a value twice as large as a stress applying part interval a by a mode field diameter d at the wavelength of 1.55 μm, is between 1.091 and 1.226, inclusive, and
the stress applying part interval a is a half of the shortest distance between the paired stress applying parts.

20. The polarization maintaining fiber according to claim 1, wherein a normalized stress applying part diameter t/b, obtained by normalizing a stress applying part diameter t of each of the paired stress applying parts by a clad diameter b, is between 0.281 and 0.319, inclusive.

21. The polarization maintaining fiber according to claim 1, wherein the clad has a clad diameter equal to or less than 80 μm.
